(19) United States
(12) Patent Application Publication
(10) Pub. No.: US 2010/0253033 A1
(43) Pub. Date: Oct. 7, 2010

(54) Suspension attachment for cargo vehicle

(76) Inventor: Sen Lung Chen, Taichung Hsien (TW)

Correspondence Address: CHARLES E. BAXLEY, ESQUIRE, 90 JOHN STREET, SUITE 309, NEW YORK, NY, 10038, US

(21) Appl. No.: 12/384,518

(22) Filed: Apr. 6, 2009

(51) Int. Cl. B60G 11/10

(52) U.S. Cl. 280/124.175

(57) ABSTRACT

A cargo vehicle suspension attachment includes two beams attached to a vehicle frame, two brackets attached to the beams, two fasteners attached to the brackets and engaged with the upper portions of the shock absorbing devices, a wheel carrier attached to the frame, two supports attached to the wheel carrier, and two fasteners attached to the supports and engaged with the lower portions of the shock absorbing devices for mounting the shock absorbing devices between the frame and the wheel carrier for absorbing the shocks or the vibrations or the pulsations that may be transmitted to the frame and the wheel carrier or the wheels of the heavy or cargo vehicle.

### BACKGROUND OF THE INVENTION

1. Field of the Invention

The present invention relates to a suspension attachment for cargo vehicle, trailer, truck or the like, and more particularly to a suspension attachment for a cargo vehicle including an additional shock absorbing device, in addition to the conventional or typical leaf spring stacks, for shock absorbing purposes and for reducing the pulsation of the cargo vehicle.

2. Description of the Prior Art

Typical suspension systems for the larger vehicles, such as the cargo vehicles, the trailers, the trucks or other heavy vehicles comprise one or more leaf spring stacks attached or disposed or mounted between the chassis or the frame of the heavy vehicles and the wheels for shock absorbing purposes.

For example, U.S. Pat. No. 6,056,305 to Pribyl discloses one of the typical steering axle suspension systems comprising one or more leaf spring stacks or air springs attached or disposed or mounted between the chassis or the frame of the heavy vehicles and the wheels for shock absorbing purposes.

However, the typical leaf spring stacks may not suitably absorb the shocks or the vibrations that may be transmitted-to the chassis or the frame of the heavy vehicles, and the typical air springs comprise a complicated structure that may not be easily manufactured and assembled and that may include a greatly increased manufacturing cost.

The present invention has arisen to mitigate and/or obviate the afore-described disadvantages of the conventional suspension attachments for the vehicle.

### SUMMARY OF THE INVENTION

The primary objective of the present invention is to provide a cargo vehicle suspension attachment including an additional shock absorbing device, in addition to the conventional or typical leaf spring stacks, for absorbing the shocks or the vibrations that may be transmitted to the frame of the heavy or cargo vehicle and for reducing the shocks or the vibrations or the pulsations of the frame and the wheel carrier and/or the wheels.

In accordance with one aspect of the invention, there is provided a cargo vehicle suspension attachment comprising a frame, two beams attached to a bottom portion of the frame, two brackets attached to the beams, two shock absorbing devices each including an upper portion and a lower portion, two first fasteners attached to the brackets and engaged with the upper portions of the shock absorbing devices, a wheel carrier attached to the bottom portion of the frame, two supports attached to the wheel carrier, and two second fasteners attached to the supports and engaged with the lower portions of the shock absorbing devices for solidly mounting the shock absorbing devices between the frame and the wheel carrier for absorbing the shocks or the vibrations that may be transmitted to the frame of the heavy or cargo vehicle and for reducing the shocks or the vibrations of the frame and the wheel carrier and/or the wheels.

The first fasteners include a threaded segment extended out of the brackets and extended toward each other and engaged with the upper portions of the shock absorbing devices. The second fasteners include a threaded segment extended out of the supports and extended toward each other and engaged with the lower portions of the shock absorbing devices.

The beams include a U-shaped structure having open ends facing toward each other and having close ends facing away from each other. The brackets are attached to the beams and have close ends facing toward each other and have open ends facing away from each other.

One or more leaf spring stacks may further be provided and attached or disposed or mounted between the frame and the wheel carrier of the vehicle wheels for further shock absorbing purposes and for suitably absorbing the shocks or the vibrations that may be transmitted to the frame of the heavy or cargo vehicle and for reducing the shocks or the vibrations of the frame and the wheel carrier and/or the wheels.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial perspective view of a heavy or cargo vehicle suspension attachment in accordance with the present invention;

FIG. 2 is a partial exploded view of the suspension attachment for the cargo vehicle;

FIG. 3 is a partial rear plan schematic view of the suspension attachment for the cargo vehicle; and

FIG. 4 is a partial cross sectional view illustrating the operation of the suspension attachment for the heavy or cargo vehicle.

### DETAILED DESCRIPTION OF THE PREFERRED EMBODIMENT

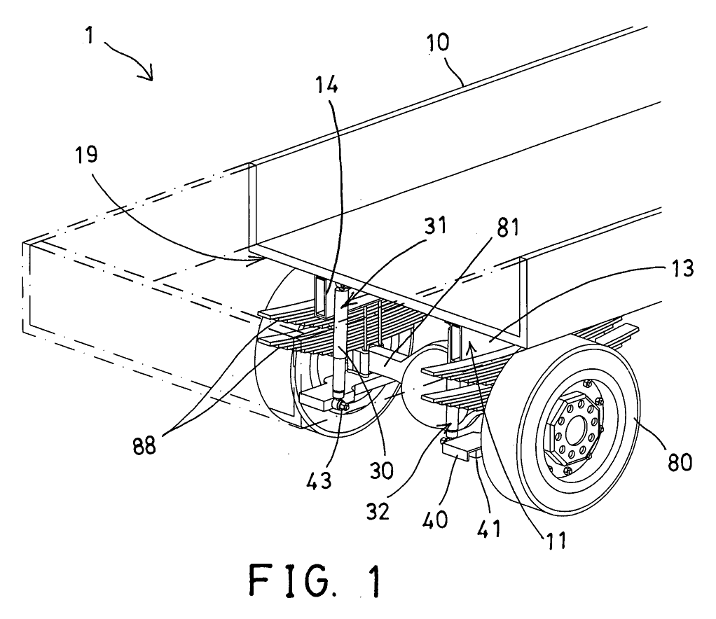

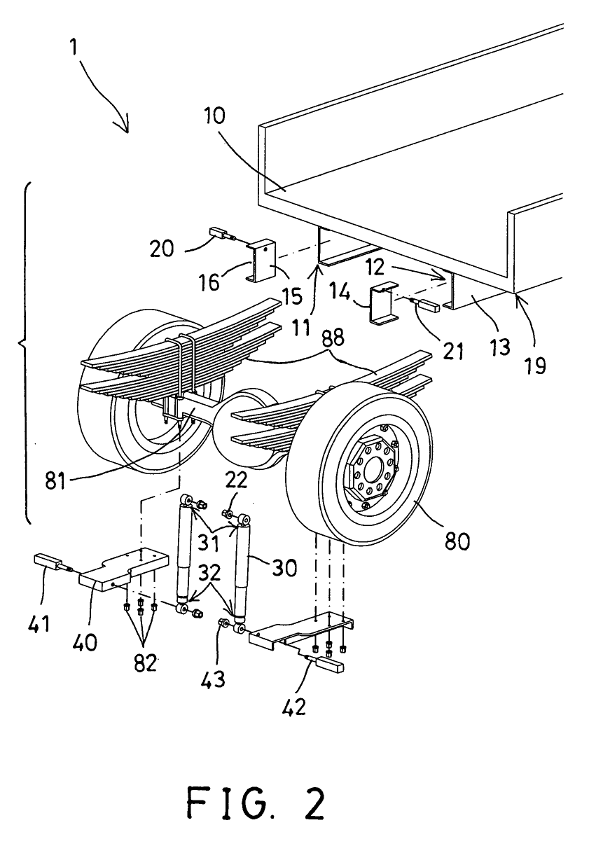

Referring to the drawings, and initially to FIGS. 1-3, a heavy vehicle 1, such as a cargo vehicle, a trailer, a truck or the other heavy vehicle 1 in accordance with the present invention comprises a chassis or frame 10 including two C-shaped beams 11 attached or disposed or mounted to the bottom portion of the frame 10, and the two beams 11 are disposed opposite to each other having the open sides or ends 12 facing toward each other (FIG. 2), and having the close sides or ends 13 facing away from each other or distal to each other, two U or C-shaped brackets 14 are mounted or attached onto or engaged into the open ends 12 of the beams 11 and secured to the beams 11 with latches or fasteners (not shown), or by welding processes.

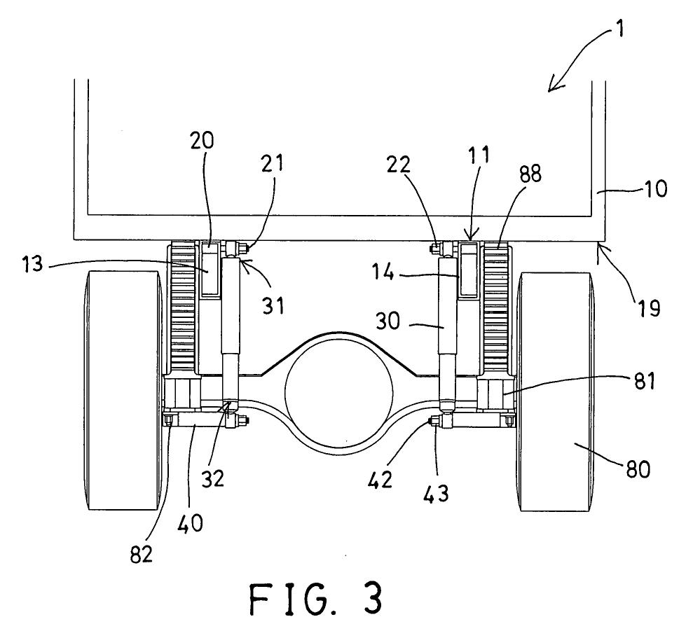

The brackets 14 are also disposed opposite to each other having the close sides or ends 15 facing toward each other (FIG. 2), and having the open sides or ends 16 facing away from each other or distal to each other and facing toward the close sides or ends 13 of the beams 11 for forming an O-shaped structure (FIGS. 1, 3). Two anchors or fasteners 20 are attached or disposed or mounted to the brackets 14 and/or the beams 11, and each include a threaded segment 21 extended out of the brackets 14 and extended toward each other (FIG. 3) for attaching or mounting an upper portion 31 of a shock absorbing device 30, and a lock nut 22 may be threaded or engaged with the threaded segment 21 of the fastener 20 for solidly securing the shock absorbing device 30 to the brackets 14 and/or the beams 11.

The heavy vehicle or cargo vehicle 1 further includes two or more rear wheels 80 attached or disposed or mounted to the rear portion and the bottom portion of the frame 10 with a wheel carrier 81, and one or more leaf spring stacks 88 attached or disposed or mounted between the frame 10 of the heavy or cargo vehicle 1 and the wheel carrier 81 for shock absorbing purposes. Two further carriers or brackets or supports 40 are attached or disposed or mounted to the wheel carrier 81 with latches or fasteners 82, and two further anchors or fasteners 41 are attached or disposed or mounted to the supports 40, and each include a threaded segment 42 extended out of the supports 40 and extended toward each other (FIG. 3) for attaching or mounting a lower portion 32 of the shock absorbing device 30, and a lock nut 43 may be threaded or engaged with the threaded segment 42 of the fastener 41 for solidly securing the shock absorbing device 30 to the supports 40 and/or the wheel carrier 81.

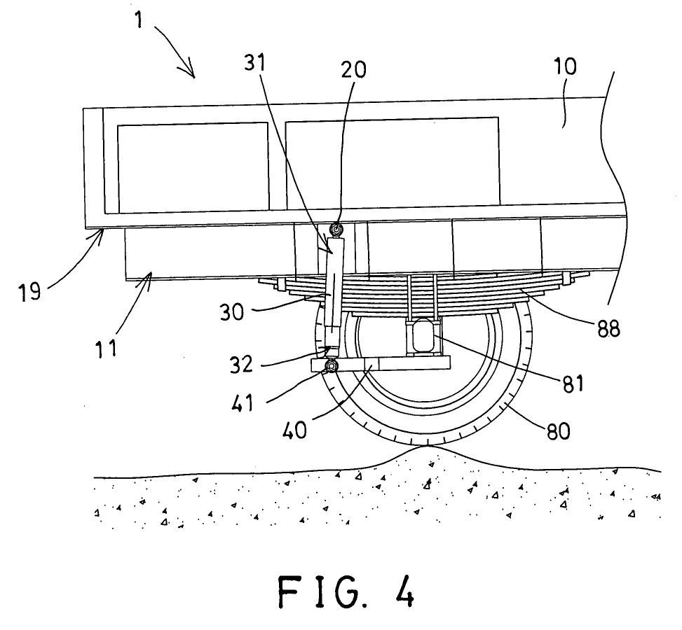

As shown in FIGS. 1 and 3-4, the heavy or cargo vehicle 1 thus includes one or more conventional or typical leaf spring stacks 88 attached or disposed or mounted between the frame 10 and the wheel carrier 81 for shock absorbing purposes, and further includes one or more shock absorbing devices 30 attached or disposed or mounted between the frame 10 and the wheel carrier 81 for further shock absorbing purposes and for suitably absorbing the shocks or the vibrations that may be transmitted to the frame 10 of the heavy or cargo vehicle 1 (FIG. 4) and for reducing the shocks or the vibrations of the frame 10 and the wheel carrier 81 and/or the wheels 80.

Accordingly, the cargo vehicle suspension attachment in accordance with the present invention includes an additional shock absorbing device, in addition to the conventional or typical leaf spring stacks, for shock absorbing purposes and for reducing the pulsation of the cargo vehicle.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A cargo vehicle suspension attachment comprising:
a frame,
two beams attached to a bottom portion of said frame,
two brackets attached to said beams,
two shock absorbing devices each including an upper portion and a lower portion,
two first fasteners attached to said brackets and engaged with said upper portions of said shock absorbing devices,
a wheel carrier attached to the bottom portion of said frame,
two supports attached to said wheel carrier, and
two second fasteners attached to said supports and engaged with said lower portions of said shock absorbing devices for mounting said shock absorbing devices between said frame and said wheel carrier for shock absorbing purposes.

2. The cargo vehicle suspension attachment as claimed in claim 1, wherein said first fasteners include a threaded segment extended out of said brackets and extended toward each other and engaged with said upper portions of said shock absorbing devices.

3. The cargo vehicle suspension attachment as claimed in claim 1, wherein said beams include a U-shaped structure having open ends facing toward each other and having close ends facing away from each other.

4. The cargo vehicle suspension attachment as claimed in claim 3, wherein said brackets are attached to said beams and have close ends facing toward each other and have open ends facing away from each other.

5. The cargo vehicle suspension attachment as claimed in claim 1, wherein said second fasteners include a threaded segment extended out of said supports and extended toward each other and engaged with said lower portions of said shock absorbing devices.

6. The cargo vehicle suspension attachment as claimed in claim 1, wherein at least one leaf spring stack is mounted between said frame and said wheel carrier.
